(19) United States
(12) Patent Application Publication
(10) Pub. No.: US 2006/0215395 A1
(43) Pub. Date: Sep. 28, 2006

(54) BENDABLE TOOL SHANK WITH LIGHT MEANS

(76) Inventor: Jen-Yen Yen, Yenpu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/088,732

(22) Filed: Mar. 25, 2005

(51) Int. Cl. B25B 23/18

(52) U.S. Cl. 362/119

(57) ABSTRACT

A bendable tool shank is disclosed to include a rod of metal spiral spring, which has a first metal connector at one end and a second metal connector at the other end, an armored tube surrounding the rod of metal spiral spring, a battery-based power source assembly rotatably coupled to the rod of metal spiral spring around the first metal connector, and a light source assembly rotatably coupled to the rod of metal spiral spring around the second metal connector for giving off light when the user switched on the power switch of the battery-based power source assembly.

### BACKGROUND OF THE INVENTION

1. Field of the Invention

The present invention relates to a tool shank and more particularly, to a bendable too shank, which has one end provided with a rotatable battery-based power source assembly and the other end provided with a rotatable light source assembly that is electrically connected to the battery cells in the rotatable battery-based power source assembly through a power switch.

2. Description of the Related Art

A bendable tool shank is practical for use with a driving member and a tip to rotate a screw bolt or nut in a curved hole. A conventional bendable tool shank is known comprising a rod of metal spiral spring, a first connector provided at one end of the rod of metal spiral spring for receiving a driving member, and a second connector provided at the other end of the rod of metal spiral spring for holding a tip. This design of bendable tool shank is till not satisfactory in function for the drawbacks stated below:

1. The bendable tool shank is not suitable for use under a dark environment because it has no means to give off light for illumination.

2. Because the first connector and the second connector are respectively affixed to the two ends of the rod of metal spiral spring, the metal spiral spring will be rotated with the two connectors during working. Therefore, the user needs to employ much effort to rotate the bendable tool shank during working.

### SUMMARY OF THE INVENTION

The present invention has been accomplished under the circumstances in view. According to one aspect of the present invention, the bendable tool shank comprises a bendable rod member, which has a first metal connector and a second metal connector respectively provided at two distal ends of a rod of metal spiral spring thereof, a battery-based power source assembly coupled to one end of the bendable rod member around the first connector, and a light source assembly coupled to the other end of the bendable rod member around the second connector and controllable by a power switch at the power source assembly to give off light for illumination. According to another aspect of the present invention, the battery-based power source assembly and the light source assembly are respectively rotatable relative to the rod of metal spiral spring and the connectors. According to still another aspect of the present invention metal axle bearings are provided to support the battery-based power source assembly and the light source assembly on the two connectors of the bendable rod member respectively, allowing smooth rotation of the battery-based power source assembly and the light source assembly relative to the connectors.

### BRIEF DESCRIPTION OF THE DRAWINGS

FIG. 1 is an exploded view of a bendable tool shank according to the present invention.

FIG. 2 is a schematic sectional view showing the bendable tool shank set in a straight manner and the rod of metal spiral spring rotated with the first and second metal connectors relative to the armored tube and the power source assembly and the light source assembly.

FIG. 3 is similar to FIG. 2 but showing a curved status of the bendable rod member.

FIG. 4 is an elevational view showing the outer appearance of the bendable tool shank according to the present invention.

FIG. 5 is a schematic sectional view of an alternate form of the present invention, showing the electric wire arranged inside the armored tube.

### DETAILED DESCRIPTION OF THE PREFERRED EMBODIMENT

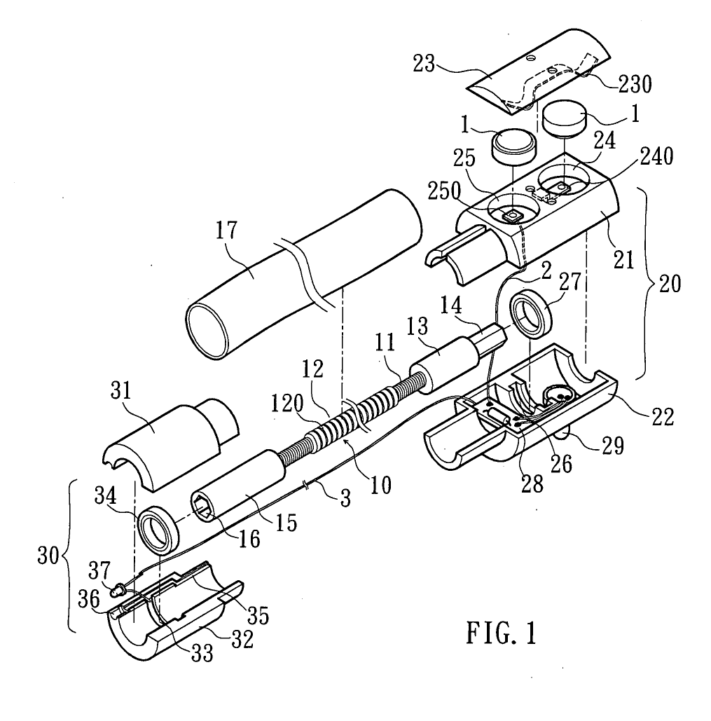

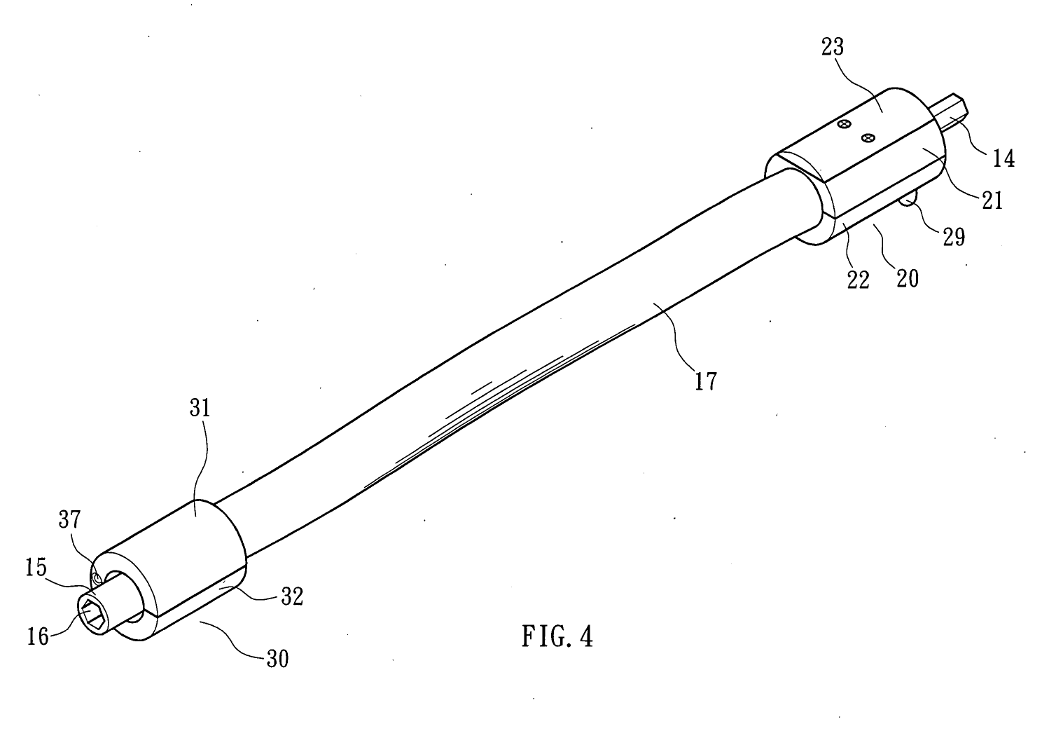

Referring to FIGS. 1-4, a bendable tool shank in accordance with the present invention is shown comprised of a bendable rod member 10, a power source assembly 20, and a light source assembly 30.

The bendable rod member 10 comprises a rod of metal spiral spring 11, a first metal connector 13 fixedly connected to one end of the rod of metal spiral spring 11 and terminating in a hexagonal coupling tip 14, a second metal connector 15 fixedly connected to the other end of the rod of metal spiral spring 11 and defining therein an axially extended hexagonal coupling hole 16, an armored tube 12 surrounding the rod of metal spiral spring 11 between the first metal connector 13 and the second metal connector 15, and a protective sleeve 17 formed of a plurality of metal rings 120 sleeved onto the armored tube 12 around the rod of metal spiral spring 11. The armored tube 12 is formed of a plurality of metal rings 120 that are riveted to one another.

The power source assembly 20 is rotatably coupled to one end of the bendable rod member 10 around the first metal connector 13, comprising a housing formed of top cover shell 21 and a bottom cover shell 22, a metal axle bearing 27 mounted in a locating groove 26 in each of the top cover shell 21 and the bottom cover shell 22 and coupled to the first metal connector 13 of the bendable rod member 10 to hold the first metal connector 13 in such a position that the hexagonal coupling tip 14 of the first metal connector 13 is suspending outside the housing of the top and bottom cover shells 21;22, a circuit board 28 mounted inside the bottom cover shell 22, a first metal contact plate 240 mounted in a first battery well 24 in the top cover shell 21 disposed in contact with the metal axle bearing 27, a second metal contact plate 250 mounted in a second battery well 25 in the top cover shell 21 and electrically connected to the circuit board 28 through a lead wire 2, two battery cells 1 respectively mounted in the battery wells 24;25 and respectively kept in contact with one of the two terminals of each of the battery cells 1, a battery lid 23 fastened to the top cover shell 21 to hold the battery cells 1 in place, a metal conducting strip 230 fixedly provided at the bottom side of the battery lid 23 and pressed on the other of the two terminals of each of the battery cells 1, and a power switch 29 adapted to switch on/off (close/open) the circuit of the circuit board 28. The circuit board 28 has the positive and negative terminals thereof respectively connected to the lead wire 2 and the metal axle bearing 27. Therefore, when switching on the power switch 29, the battery cells 1 are electrically connected to the circuit board 28. On the contrary, when switching off the power switch 29, the battery cells 1 are electrically disconnected from the circuit board 28.

The light source assembly 30 is rotatably coupled to the other end of the bendable rod member 10 around the second metal connector 15, comprising a housing formed of a top cover shell 31 and a bottom cover shell 32, a metal axle bearing 34 mounted in a locating groove 33 in each of the top cover shell 31 and the bottom cover shell 32 and coupled to the second metal connector 15 of the bendable rod member 10 to hold the second metal connector 15 in such a position that the hexagonal coupling hole 14 of the second metal connector 15 is exposed to the outside the housing of the top and bottom cover shells 31;32, a light emitting element, for example LED 37 mounted in a lamp hole 36 in the housing of the cover shells 31;32, and an electric wire 3 inserted through a wire hole 35 and connected between one terminal of the LED 37 and one terminal of the circuit board 28. The LED 37 has the positive and negative terminals thereof respectively electrically connected to the positive and negative terminal of the circuit board 28 through the electric wire 3 and the metal axle bearing 34, which is kept in contact with the bendable rod member 10.

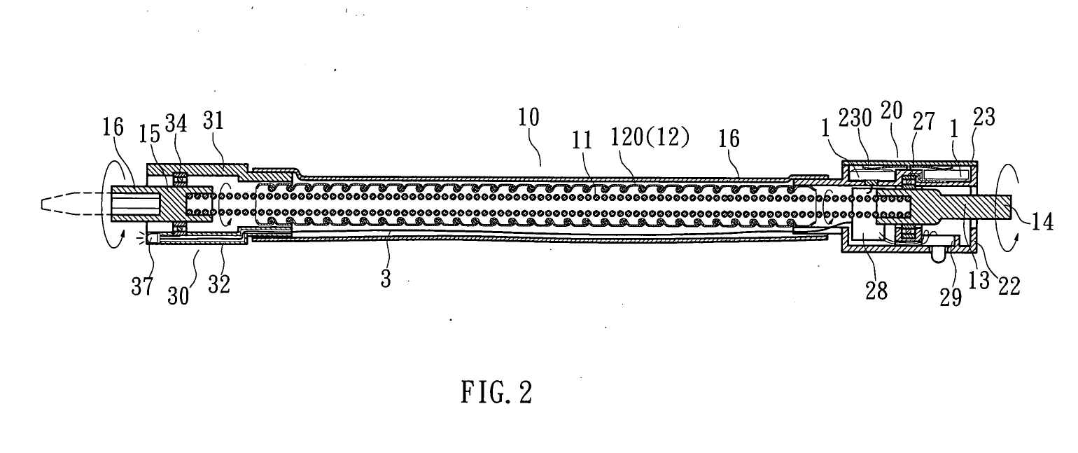

Referring to FIG. 2 again, when rotating the coupling tip 14 of the first metal connector 13 of the bendable rod member 10 with a rotary power drive or wrench means, the rod of metal spiral spring 11 and the second metal connector 15 with the attached tool tip (for example, screwdriver tip) are rotated with the first metal connector 13 relative to the armored tube 12, the power source assembly 20 and the light source assembly 30. Therefore, the user can hold the protective sleeve 17, the housing of the cover shells 21;22 of the power source assembly 20, or the housing of the cover shell 31;32 of the light source assembly 30 with the hand when rotating the metal connectors 13;15 and the rod of metal spiral spring 11.

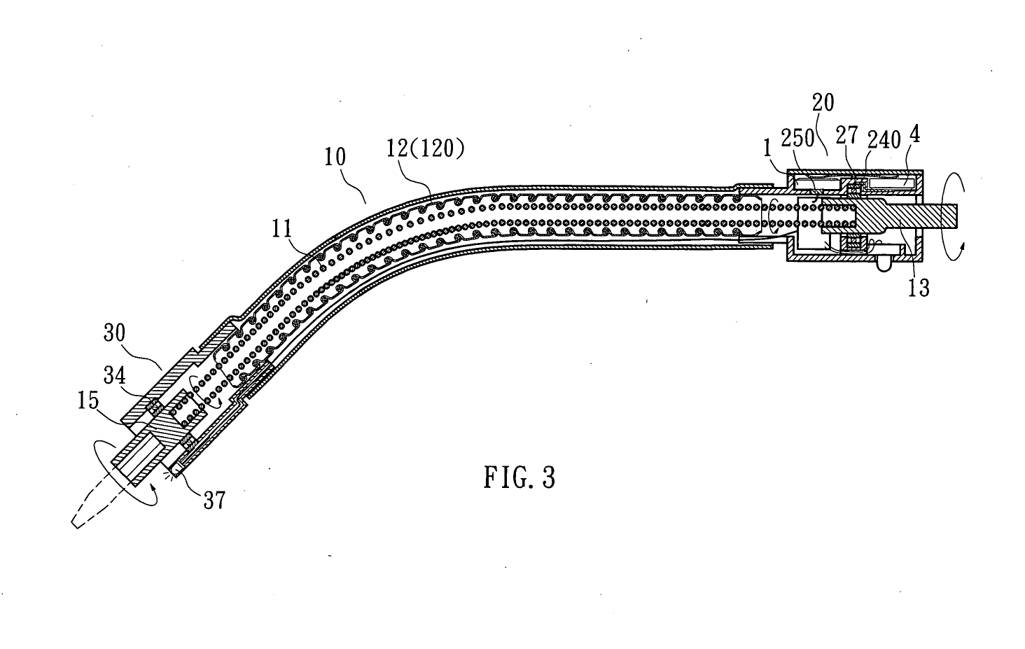

Referring to FIG. 3, the user can bend the bendable rod member 10 to the desired angle. After having bent the bendable rod member 10 to the desired angle, the user can still rotate the metal connectors 13;15 and the rod of metal spiral spring 11 relative to the armored tube 12, the power source assembly 20 and the light source assembly 30.

Further, because the housing of the cover shells 21;22 of the power source assembly 20 and the housing of the cover shell 31;32 of the light source assembly 30 are respectively rotatably supported on the metal connectors 13;15 of the bendable rod member 10 by the metal axle bearings 27;34, the rod of metal spiral spring 11 can be rotated with the metal connectors 13;15 relative to the armored tube 12, the power source assembly 20 and the light source assembly 30 smoothly. The cover shells 21;22 of the power source assembly 20 and the cover shell 31;32 of the light source assembly 30 are preferably injection-molded from plastics for the advantages of low manufacturing cost.

As stated above, the first metal contact plate 240 is maintained in contact with the metal axle bearing 27 of the power source assembly 20; the metal axle bearing 27 is maintained in contact with the first metal connector 13 at one end of the rod of metal spiral spring 11; the second metal connector 15 at the other end of the rod of metal spiral spring 11 is maintained in contact with the metal axle bearing 34; the metal axle bearing 34 is connected to one terminal of the LED 37; the LED 37 has the other terminal connected to the circuit board 28 through the electric wire 3 and then connected to the second metal contact plate 250 through the lead wire 2 via the power switch 29; the battery cells 1 each have one terminal respectively maintained in contact with the metal contact plates 240; 250 and the other terminal respectively maintained in contact with the metal conducting strip 230 at the battery lid 23. Therefore, when the user switched on the power switch 29, the LED 37 is turned on to give off light for illumination. On the contrary, when switched off the power switch 29, the LED 37 is off.

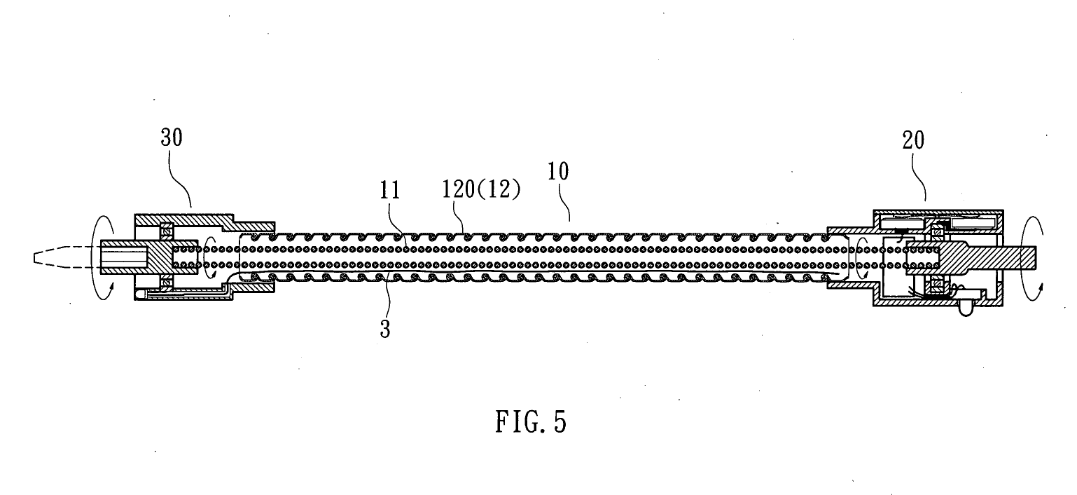

In the embodiment shown in FIGS. 2 and 3, the electric wire 3 is arranged outside the armored tube 12 within the protective sleeve 17. Alternatively, the electric wire 3 can be arranged outside the rod of metal spiral spring 11 and surrounded by the armored tube 12 as shown in FIG. 5.

A prototype of bendable tool shank has been constructed with the features of FIGS. 1-5. The bendable tool shank functions smoothly to provide all the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A bendable tool shank comprising:
a bendable rod member, said bendable rod member comprising a first metal connector at a first end thereof and a second metal connector at a second end thereof;
a power source assembly rotatably coupled to first end of said bendable rod member, said power source assembly comprising an electrically insulative housing, a metal axle bearing mounted on said first metal connector of said bendable rod member inside the housing of said power source assembly to support said power source assembly on said bendable rod member for allowing rotation of said power source assembly on the first connector of said bendable rod member, at least one battery cell mounted inside the housing of said power source assembly, a power switch, and a circuit board mounted in the housing of said power source assembly, said circuit board having a positive terminal and a negative terminal respectively electrically connected to positive and negative terminals of said at least one battery cell through said power switch; and
a light source assembly rotatably coupled to the second end of said bendable rod member, said light source assembly comprising an electrically insulative housing, a metal axle bearing mounted on the second metal connector of said bendable rod member inside the housing of said light source assembly to support said light source assembly on said bendable rod member for allowing rotation of said light source assembly on the second connector of said bendable rod member, and a light emitting element mounted in the housing of said light source assembly, said light emitting element having a first terminal electrically connected to said circuit board through an electric wire and a second terminal electrically connected to the metal axle bearing of said light source assembly such that said light emitting element is turned on/off when the user switched on/off said power switch.

2. The bendable tool shank as claimed in claim 1, further comprising a protective sleeve surrounding said bendable rod member.

3. The bendable tool shank as claimed in claim 1, wherein said bendable rod member comprises a rod of metal spiral spring connected between said first metal connector and said second metal connector, an armored tube formed of a plurality of riveted metal rings and sleeved onto said rod of metal spiral spring.
